(19) United States
(12) Patent Application Publication
(10) Pub. No.: US 2009/0138479 A1
(43) Pub. Date: May 28, 2009

(54) SYSTEM AND METHOD FOR SENDING DATA STORING REQUESTS IN SEQUENCE

(75) Inventor: CHIH-HUNG CHIU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/967,047

(22) Filed: Dec. 29, 2007

(30) Foreign Application Priority Data
Nov. 23, 2007 (CN) 200710202645.3

(51) Int. Cl. G06F 17/30

(52) U.S. Cl. 707/10; 707/E17.009

(57) ABSTRACT

A computer-based method for sending data storing requests in sequence is disclosed. The method includes the steps of: receiving a data storing request sent from a thread in a client computer; inserting the data storing request into the end of a request queue in the client computer; sending the first request in the request queue to an application server electronically connected with the client computer, deleting the first request in the request queue, and moving a location of each remaining request, in the request queue, forward accordingly; storing data corresponding to the first request in a database by the application server. A related system is also disclosed.

### BACKGROUND OF THE INVENTION

1. Field of the Invention

The present invention is related to a system and method for sending data storing requests in sequence.

2. Description of Related Art

Database connections management is important to the development of database application software. However, connections to a database may depend on the number of factors, the number of connections may be a single hard-coded number embedded in the software, or the software may be programmed to vary the number of connections depending on the amount of memory and/or the speed of the hardware. In the case of the hard-coded limit, if the number of the database connection requests is more than the limit of the number of the database connections, additional connection requests may be dropped after being queued for a certain time-out period. In the case of the varying number of connections, if they are too many simultaneous connection requests, the database may overload and mal-function. This mal-function may cause inconvenience and monetary loss.

Therefore, what is needed is a system and method for sending data storing requests in sequence which can prevent the database from mal-functioning.

### SUMMARY OF THE INVENTION

A system for sending data storing requests in sequence is provided in accordance with a preferred embodiment. The system includes plural client computers and an application server. The application server is connected to each client computer through a network. The application server has a database therein. Each client computer includes a data storing management unit. The data storing management unit includes a request receiving module, an inserting module, a judging module, and a request sending module. The request receiving module is configured for receiving a data storing request sent from a thread in the client computer. The inserting module is configured for inserting the data storing request into the end of a request queue in the client computer. The judging module is configured for judging whether the data storing request is the first one in the request queue. The request sending module is configured for sending the first request in the request queue to the application server, deleting the first request in the request queue, and moving a location of each remaining request, in the request queue, forward accordingly after sending the first request to the application server. The application server is configured for storing data corresponding to the first request in the database.

A computer-based method for sending data storing requests in sequence is also provided. The method includes the steps of: receiving a data storing request sent from a thread in a client computer; inserting the data storing request into the end of a request queue in the client computer; sending the first request in the request queue to an application server electronically connected with the client computer, deleting the first request in the request queue, and moving a location of each remaining request, in the request queue, forward accordingly; storing data corresponding to the first request in a database by the application server.

Other systems, methods, features, and advantages of the present invention will become apparent to one with skill in the art upon examination of the following drawings and detailed description.

### BRIEF DESCRIPTION OF THE DRAWINGS

FIG. 1 is a schematic diagram of hardware configuration of a system for sending data storing requests in sequence in accordance with a preferred embodiment;

FIG. 2 is a schematic diagram showing function modules of a client computer of FIG. 1; and

FIG. 3 is a flowchart of a preferred method for sending data storing requests in sequence in accordance with one embodiment.

### DETAILED DESCRIPTION OF THE INVENTION

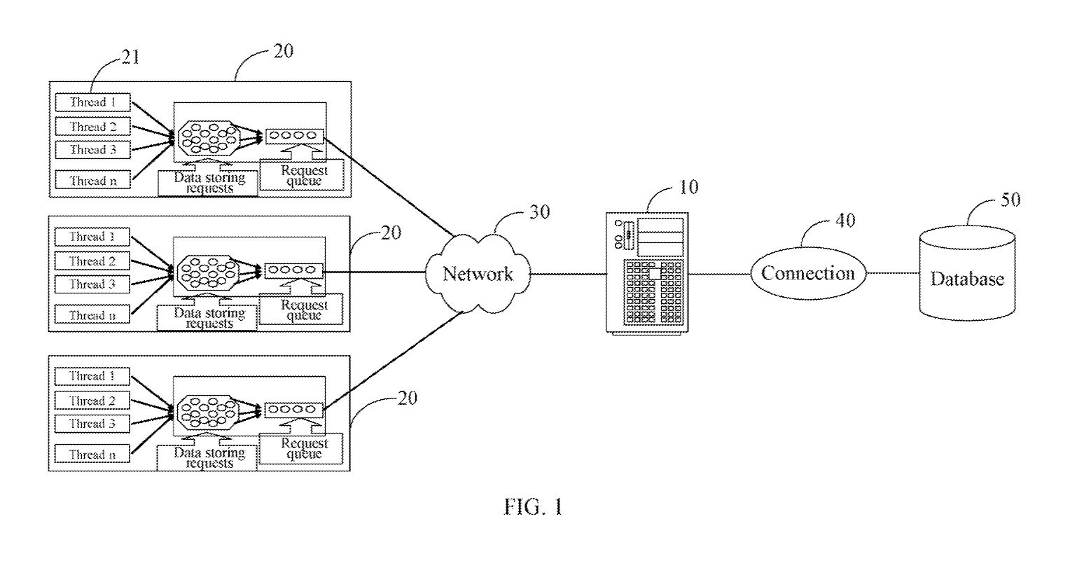

FIG. 1 is a schematic diagram of hardware configuration of a system for sending data storing requests in sequence (hereinafter, “the system”) in accordance with a preferred embodiment. The system typically includes an application server 10, a database 50, and plural client computers 20. The application server 10 connects with the plural client computers 20 through a network 30. The application server 10 is configured for receiving data storing requests sent from the plural client computers 20, and storing data corresponding to each data storing request in the database 50. Each client computer 20 provides an operation interface for users to send data or instructions to the application server 10 through the network 30. For example, the user can send test data of a production line to the application server 10. The network 30 may be an Intranet or the Internet, etc.

The application server 10 connects with the database 50 through a connection 40. The connection 40 is a database connection such as an Open Database Connectivity (ODBC) or a Java Database Connectivity (JDBC). The database 50 is configured for storing data such as the test data sent from each client computer 20. The database 50 can be a database server or a storage device of the application server 10.

Generally, there may be plural threads 21 (such as Thread 1, Thread 2, Thread 3, . . . , Thread n) running in each client computer 20 at the same time. Each thread 21 is defined a task in the client computer 20, such as reading a file, writing a file, sending data, or receiving data. Before a data storing request is sent to the application server 10 from one of the client computers 20, the data storing request is inserted into a request queue in the client computer 20. Each time, only one request in each client computer 20, that is, the first request in the request queue in each client computer 20, can be sent to the application server 10. Thus, the number of connections with the database 50 is at all time, equal to or less than the number of the client computers 20, thus the burden of data processing in the database 50 is reduced.

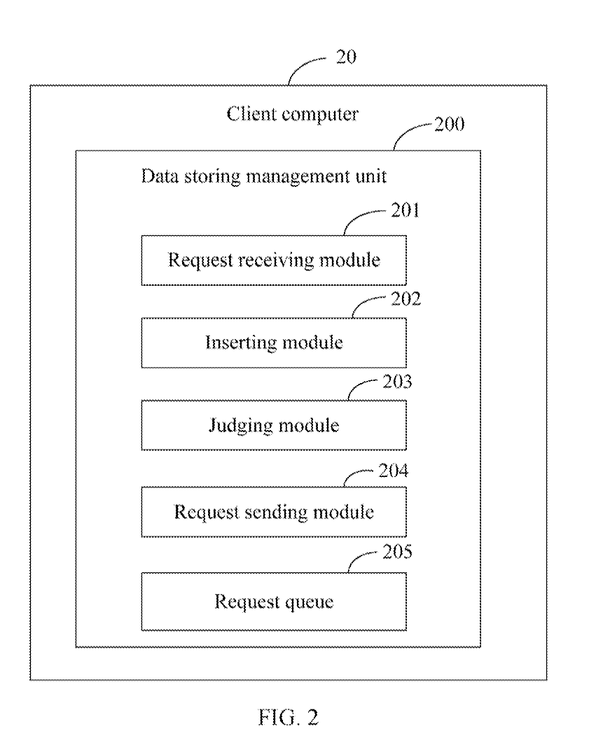

FIG. 2 is a schematic diagram showing function modules of one of the client computers 20 of FIG. 1. The client computer 20 may include a data storing management unit 200. The data storing management unit 200 may include a request receiving module 201, an inserting module 202, a judging module 203, a request sending module 204, and a request queue 205.

The request receiving module 201 is configured for receiving a data storing request sent from one thread 21 in the client computer 20.

The inserting module 202 is configured for inserting the data storing request into the end of the request queue 205.

The judging module 203 is configured for judging whether the data storing request is the first one in the request queue 205 (i.e., judging whether the data storing request is the first request inserted into the request queue 205).

The request sending module 204 is configured for creating a connection between the client computer 20 and the application server 10, and sending the data storing request to the application server 10 if the data storing request is the first one in the request queue 205. If the data storing request is not the first one in the request queue 205, the request sending module 204 locates the first one in the request queue 205, and sends the first request in the request queue 205 to the application server 10.

The request sending module 204 is further configured for deleting the first request in the request queue 205, and moving a location of each remaining request, in the request queue 205, forward accordingly after sending the first request to the application server 10. The request sending module 204 sends the data storing requests in the request queue 205 in sequence according to an FIFO (First-In First-Out) rule. That is to say, the first data storing request inserted into the request queue 205 will be sent to the application 10 first, and the last data storing request inserted into the request queue 205 will be sent to the application server 10 last. Thus, only one data storing request from the client computer 20 is processed by the database 50 at a time, and the number of connections with the database 50 is reduced.

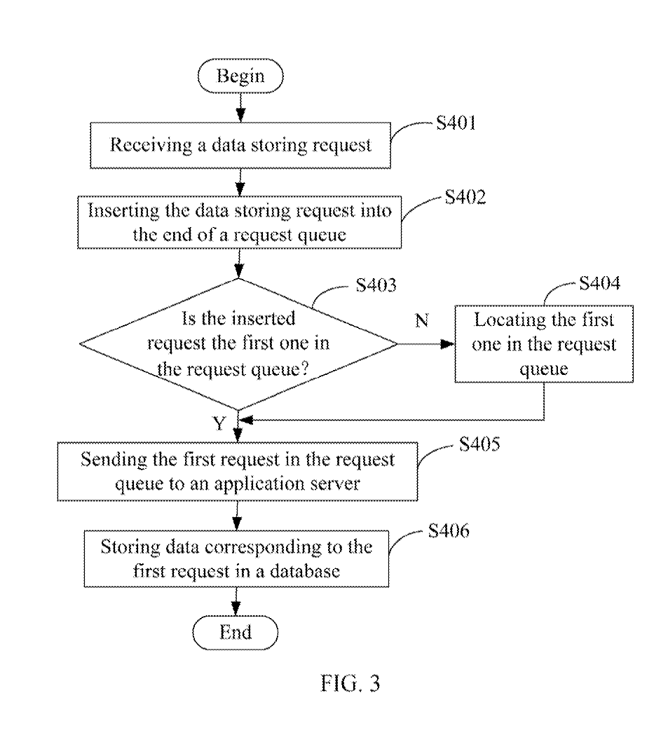

FIG. 3 is a flowchart of a preferred method for sending data storing requests in sequence in accordance with one embodiment. In step S401, the request receiving module 201 receives a data storing request sent from one thread 21 in one of the plural client computers 20.

In step S402, the inserting module 202 inserts the data storing request into the end of the request queue 205.

In step S403, the judging module 203 judges whether the inserted data storing request is the first one in the request queue 205 (i.e., judges whether the data storing request is the first request inserted into the request queue 205). If the inserted data storing request is not the first one in the request queue 205, the procedure goes to step S404. Otherwise, the procedure goes to step S405 directly.

In step S404, the request sending module 204 locates the first one in the request queue 205, then the procedure goes to step S405.

In step S405, the request sending module 204 creates a connection between one of the client computer 20 and the application server 10, sends the first request in the request queue 205 to the application server 10, deletes the first request in the request queue 205 after sending the first request, and moves a location of each remaining request, in the request queue 205, forward accordingly. The request sending module 204 sends the data storing requests in the request queue 205 in sequence according to the FIFO (First-In First-Out) rule. That is to say, the first data storing request inserted into the request queue 205 will be sent to the application 10 first, and the last data storing request inserted into the request queue 205 will be sent to the application server 10 last. Thus, only one data storing request from the client computer 20 is processed by the database 50 at a time, and the number of connections with the database 50 is reduced.

In step S406, application server 10 receives the data storing request sent from the client computer 20, and stores data corresponding to the first request in the database 50.

It should be emphasized that the above-described embodiments of the present invention, particularly, any preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for sending data storing requests in sequence, the system comprising plural client computers and an application server, the application server being connected to each client computer through a network, the application server having a database therein, each client computer comprising a data storing management unit, the data storing management unit comprising:
a request receiving module being configured for receiving a data storing request sent from a thread in the client computer;
an inserting module being configured for inserting the data storing request into the end of a request queue in the client computer;
a judging module being configured for judging whether the data storing request is the first one in the request queue;
a request sending module being configured for sending the first request in the request queue to the application server, deleting the first request in the request queue, and moving a location of each remaining request, in the request queue, forward accordingly after sending the first request to the application server; and
the application server being configured for storing data corresponding to the first request in the database.

2. The system according to claim 1, wherein the thread is an application program running in the client computer.

3. A computer-based method for sending data storing requests in sequence, the method comprising:
receiving a data storing request sent from a thread in a client computer;
inserting the data storing request into the end of a request queue in the client computer;
sending the first request in the request queue to an application server electronically connected with the client computer, deleting the first request in the request queue, and moving a location of each remaining request, in the request queue, forward accordingly; and
storing data corresponding to the first request in a database by the application server.

4. The method according to claim 3, wherein the thread is an application program running in the client computer.
